(19) United States
(12) Patent Application Publication
(10) Pub. No.: US 2013/0215366 A1
(43) Pub. Date: Aug. 22, 2013

(54) Liquid Crystal Display Panel and Method for Making the Same

(71) Applicant: Cheng-hung Chen, Shenzhen (CN)

(72) Inventor: Cheng-hung Chen, Shenzhen (CN)

(73) Assignee: Shenzhen China Star Optoelectronics Technology Co. LTD., Shenzhen (CN)

(21) Appl. No.: 13/510,932

(22) PCT Filed: Feb. 23, 2012
(86) PCT No.: PCT/CN12/71536

§ 371 Date: May 18, 2012

(30) Foreign Application Priority Data
Feb. 21, 2012 (CN) 201210040418.6

(51) Int. Cl. G02F 1/1335; B05D 5/06; B05D 5/12

(52) U.S. Cl. 349/106; 427/58

(57) ABSTRACT

This invention discloses a liquid crystal display and a method making the same. The liquid crystal display panel includes an array substrate, a color filter substrate, a liquid crystal layer, a first and second transfer pads. The first transfer pad is disposed on the array substrate, and the second transfer pad is disposed onto the color filter substrate, and is electrically interconnected with the first transfer pad. Wherein the first and second transfer pads are surface treated to reduce the surface tension thereof before deployment of alignment layers. By this arrangement, the non-active border along the peripheral of the liquid crystal display can be reduced, and a liquid crystal display with narrowed border is achieved.

### FIELD OF THE INVENTION

The present invention relates to a technology of a display, and more particularly relates to a liquid crystal display and a method for making the same.

### DESCRIPTION OF PRIOR ART

Thin Film Transistor Liquid Crystal Display (hereinafter referred to as TFT LCD) is one of the liquid crystal display available to the market. One of the core and vital components of TFT LCD is the liquid crystal display. Currently in the LCD market, a monitor having LCD having a narrowed-frame-panel has become more and more popular.

As shown in FIG. 1, a LCD panel generally includes an array substrate 100, a color filter substrate 101, a sealing agent 102, a liquid crystal layer 103, an alignment layer 104, a conductive layer 105, and a transparent transfer pad pad 106, and a conductive ball 107. The array substrate 100 and the color filter substrate 101 are integrated to form a liquid crystal panel by means of the sealing agent 103. The liquid crystal layer 103 is sandwiched between the array substrate 100 and the color filter substrate 101. The orientation layer 104 is arranged between the liquid crystal layer 103 and the array substrate 100 or the color filter substrate 101.

The transfer pads 105 is disposed on the array substrate 100 and is separated and isolated with the liquid crystal layer 103 and the alignment layer 104. The common electrode (not labeled) of the transfer pad 105 and the array substrate 100 is interconnected, or in an alternative, the transfer pad 105 itself is the common electrode of the array substrate 100. The transfer pad 105 is disposed on the border of the active displaying area. Whereby the active displaying area is the normal displaying are of the pixels of the TFT display.

The transparent conductive layer 106 is disposed on the color filter substrate 101 so as to create a common electrode (not labeled). The transparent conductive layer 106 is also disposed with an alignment layer 104 and the alignment layer 104 is arranged in a way that it will not cover the transparent conductive layer 106 along the border. The conductive bulb 107 is disposed within the sealing agent 102. The area of both the transfer pad 105 and the transparent conductive layer 106 in which the alignment layer 104 is not disposed are commonly interconnected by the conductive bulb 107. By this arrangement, the common electrode of the array substrate and the color film common electrode on the color filter substrate 101 are interconnected.

In the current technology, the resistance of the alignment layer 104 is comparatively high. When the transfer pad 105 or the transparent conductive layer 106 is covered with the alignment layer 104, signals from the conductive layer 105 can not smoothly be transmitted to the transparent layer 104 through the conductive ball 107 such that a malfunction is detected and displayed. Accordingly, a predetermined distance has to be set between edges of the alignment layer 104 and the transfer pad 105 so as to ensure a smooth and reliable transfer of signals between the alignment layer 105 and the transparent conductive layer 106. As a result, this conventional design creates a comparatively larger inactive displaying strip between the active displaying area and the border which is against the trend of the minimization of the LCD display.

### SUMMARY OF THE INVENTION

It is an objective of the present invention to provide a LCD panel and a method to make the same in which an inactive displaying strip along the peripheral of the LCD panel can be reduced so as to perfect the realization of narrow-frame design.

In order to resolve the technical issues addressed above, the technical solution is provided by the present invention, and a liquid crystal display is provided, and which comprises an array substrate. A color filter substrate on which a color resist and a transparent conductive layer are disposed in sequence, wherein the transparent conductive layer is made from indium tin oxide. An liquid crystal layer is provided and arranged between the color filter substrate and the array substrate. The opposing surfaces of both the color filter substrate and the array substrate are incorporated with a first transfer pad, which arranged onto the array substrate, and a second transfer pad, which is arranged on the color filter substrate, electrically interconnected therebetween,. Wherein the second transfer pad is configured by deposition of color resists so as to create a conductive embossments serving as the second transfer pad which in turn in electrical interconnection with the first transfer pad. An alignment layer is further included and disposed in a first space defined by the liquid crystal layer, the array substrate, and the first transfer pad, or alternatively, disposed in a second space defined between the liquid crystal layer, the color filter substrate, and the second transfer pad, or disposed in both the first and second spaces. Wherein first and second surfaces of both the first and second transfer pads have been pre-treated so as to reduce its surface tension before deployment of the alignment layer.

Wherein the surface treatment of the both the first and second transfer pads is to apply a layer of lipophillic film.

Wherein the embossments are configured by deposition of two or more than two layers of the color resists.

Wherein a width of the embossment is smaller or equal to a width of the first transfer pad.

In order to resolve the technical issues addressed above, another technical solution is provided by the present invention, and a liquid crystal display is provided, and which comprises an array substrate. A color filter substrate is provided and incorporated with color resist and transparent conductive layer disposed thereon in sequence. An liquid crystal layer is arranged between the color filter substrate and the array substrate, opposing surfaces of both the color filter substrate and the array substrate incorporated with a first transfer pad, disposed on the array substrate, and a second transfer pad, disposed onto the color filter substrate, to establish an electrical interconnection therebetween. An alignment layer is disposed in a first space defined by the liquid crystal layer, the array substrate, and the first transfer pad, or alternatively, disposed in a second space defined between the liquid crystal layer, the color filter substrate, and the second transfer pad, or disposed both the first and second spaces. Wherein first and second surfaces of both the first and second transfer pads have been pre-treated so as to reduce its surface tension before deployment of the alignment layer.

Wherein the surface treatment of the both the first and second transfer pads is to apply a layer of lipophillic film.

Wherein the second transfer pad is formed by deposit of color resist in the form of embossment, and which is served as the second transfer pad so as to establish an electrical interconnection with the first transfer pad.

Wherein the embossments are configured by deposition of two or more than two layers of the color resists.

Wherein a width of the embossment is smaller or equal to a width of the first transfer pad.

Wherein the transparent conductive layer is made from indium tin oxide.

In order to further resolve technical issues discussed above, a method for making liquid crystal display panel according to the present invention is provided. The liquid crystal display panel is configured by an array substrate married with a color filter substrate, the array substrate is fabricated by the steps of: a) depositing a metallic layer or a transparent conductive layer over a first glass substrate so as to create a first transfer pad; b) performing a surface treatment over the first transfer pad so as to reduce a surface tension thereof; and c) deploying an alignment liquid over the first glass substrate which has been surface-treated and covering the first transfer pad so as form a first alignment layer.

The color filter substrate is configured with the steps of: d) depositing color resist on a second glass substrate, and forming a plurality of embossments by means of depositing color resist in a pre-selected area for a second transfer pad; e) depositing a transparent conductive layer over the embossments so as to form the second transfer pad; f) performing a surface treatment over the second transfer pad so as to reduce its surface tension thereof; and g) deploying an alignment liquid over the second glass substrate over the area of the second transfer pad so as to form a second alignment layer.

Wherein the surface treatment of the both the first and/or the second transfer pads is to apply a layer of lipophillic film.

Wherein the step of depositing the color resist over the second glass substrate includes the step of depositing two or more than two layers of the color resists over the second glass substrate.

Wherein a width of the embossment is smaller or equal to a width of the first transfer pad.

The advantages of the present invention is, as compared to the existing and conventional technology, both the first and second transfer pads are surface treated so as to reduce the surface tension. In addition, since the alignment layer is lipophillic, there is no concern of whether the alignment layer will mask the first and second transfer pads when deploying the alignment layer thereover. Such that the alignment layer can be directly deployed over the first and/or second transfer pads. By this arrangement, the pre-selected area or strip between the alignment layer and the first and second transfer pads can be readily omitted therefore broadening the active display area along the border of the liquid crystal display. Accordingly, the purpose of bringing a narrowed-frame liquid crystal display is therefore achieved.

### BRIEF DESCRIPTION OF DRAWINGS

FIG. 1 is a cross sectional view of a liquid crystal display made in accordance of one of the embodiments of the present invention;

FIG. 2 is a planar view of a transfer pad from an embodiment of the liquid crystal display made in according to the present invention;

FIG. 3 is a partial cross sectional view of a liquid crystal display made in accordance to the present invention;

FIG. 4 is an enlarged view of a circled portion of FIG. 4 showing a local area of the liquid crystal display made in accordance with the present invention;

FIG. 5 is a partial planar view of a local area of a first conductive layer of the liquid crystal display made in accordance with the present invention;

FIG. 6 is a partial planar view of a local area of a second conductive layer of the liquid crystal display made in accordance with the present invention;

FIG. 7 is a flow diagram showing a serial of manufacturing steps for fabricating an array substrate of a liquid crystal display made in accordance with the present invention; and

FIG. 8 is a flow diagram showing a serial of manufacturing steps for fabricating a color filter substrate of a liquid crystal display made in accordance with the present invention.

### DETAILED DESCRIPTION OF PREFERRED EMBODIMENT

A liquid crystal display panel, a liquid crystal display monitor and a method for making the same will be detailed described according to preferred embodiments such that the spirit and details of the present invention can be clearly demonstrated.

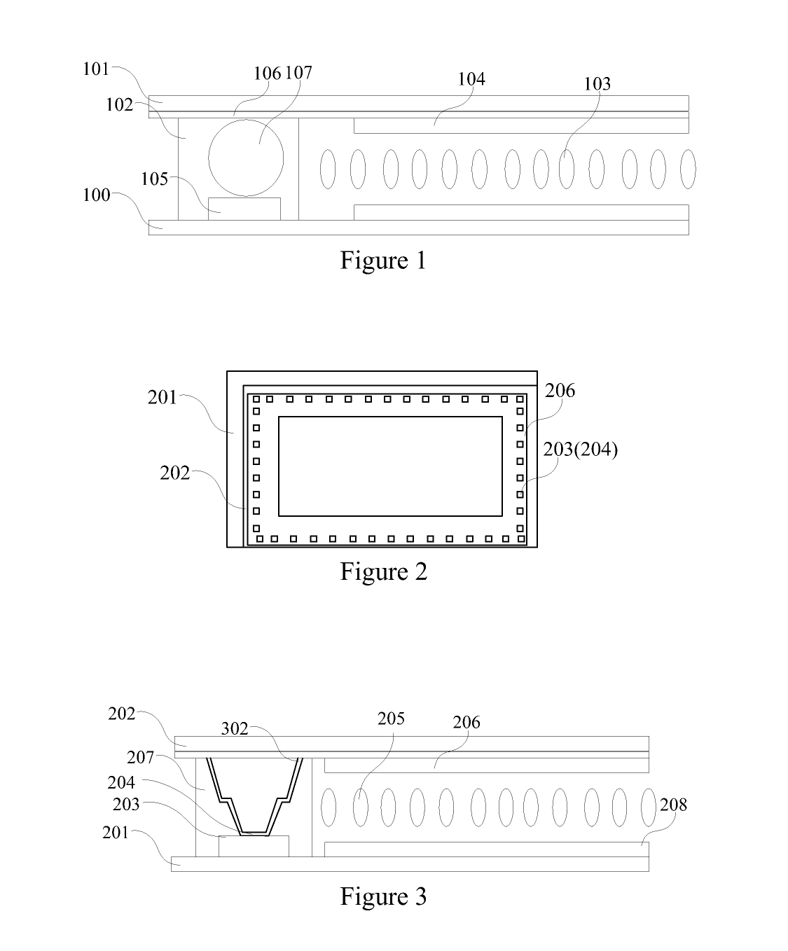

Referring to FIGS. 2 and 3, the embodiment of the liquid crystal display made in according with the present invention comprises an array substrate 201, a color filter substrate 202, a liquid crystal layer 205, a first alignment layer 206 and a second alignment layer 208.

A first transfer pad 203 is deposed onto the array substrate 201, and a second transfer pad 204 is disposed onto the color filter substrate 202. On the other hand, the color filter substrate 202 is provided with color resist (not shown) and transparent conductive film 203. The transparent conductive film 302 is made from the material of indium tin oxide or zinc tin oxide which have transparent property.

The array substrate 201 and the color filter substrate 202 is therefore married and packed with sealant 207 so as to configure a liquid crystal display. The liquid crystal layer 205 is sandwiched or filled between the color filter substrate 202 and the array substrate 201. By polarizing the orientation of the liquid crystal molecules, a display can be therefore configured. The first alignment layer 206 is disposed in a space surrounded by the liquid crystal layer 205, the array substrate 201, and the first transfer pad 203. The second alignment layer 208 is disposed in a space between the liquid crystal layer 205, the color filter substrate 202, and the second transfer pad 204. By the arrangement and provision of the first and second alignment layers 206, 208, the liquid crystal molecules within the liquid crystal layer 205 can be preset in a preset angles before it is electrified. Of course, in the other embodiment, only one of the first alignment layer 206 or the second alignment layer 208 can be deployed.

Before the first alignment layer 206 is deployed over the first transfer pad 203, and/or, the second alignment layer 208 is deployed over the second transfer pad 204, both of the first and second transfer pads 203, 204 are surface treated so as to reduce its surface tension. One of the surface treatment is deploying a lipophillic film over the first and second transfer pads 203, 204. Alternatively, other physical treatment can also be applied. It can be also treated with chemical such that the surface is transferred from hydrophilic to hydrophobic.

When the alignment liquid is deployed to form the alignment layer, it can be deployed onto the first transfer pad 203 or the second transfer pad 204. Since the alignment liquid is hydrophilic, the alignment liquid disposed onto the first transfer pad 203 or the second transfer pad 204 will be automatically runs away from the first transfer pad 203 or the second transfer pad 204. This arrangement can be effectively prevent the alignment liquid from interconnection with the first transfer pad 203 or the second transfer pad 204.

On the other hand, the pretreated area or scope of the first transfer pad 203 and the second transfer pad 204 determine the distance between the first transfer pad 203 and the first alignment layer 206, and a distance between the second transfer pad 204 and the second alignment layer 208. Accordingly, by modifying and adjusting the pre-treated area, the distance between the first transfer pad 203 and the first alignment layer 206, and the distance between the second transfer pad 204 and the second alignment layer 208 can be effectively reduced. Accordingly, the border can be effectively narrowed.

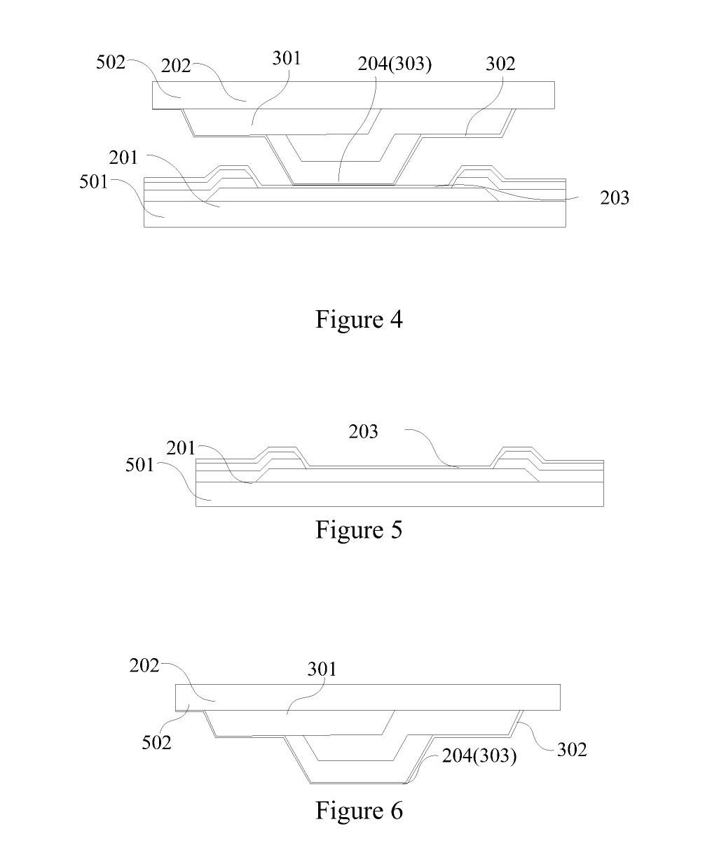

Referring to FIG. 4, which is a partial view of the configuration of the liquid crystal display shown in FIG. 3. The first transfer pad 203 is disposed onto the array substrate 201, and the second transfer pad 204 is disposed on the color filter substrate 202. In addition, the color filter substrate 202 is further disposed with three layers of color resist 301 and transparent conductive film 302 so as to form an embossment 303. The embossment 303 serves as the second transfer pad 204. The first transfer pad 203 is made from conductive material, and the first transfer pad 203 and the second transfer pad 204 are electrically interconnected so as to realize the signal transmission from the array substrate 201 to the color filter substrate 202.

Of course, two layers or more than two layers of color resist 301 can be stacked together so as to create the embossment 303. The embossment 303 along with the transparent conductive film 202 can be served as the second transfer pad 204. It should be noted that the color resist 301 in different layers can be identical, or alternatively, different from each other. By the way, a width of the embossment 303 is smaller or equal to the width of the first transfer pad 203 such that a better electrical interconnection can be readily achieved between the embossment 303 and the first transfer pad 203.

The arrangement of the embossment 303 on the color filter substrate 202 can benefit an accurate alignment between the array substrate 201 and the color filter substrate 202. As the accuracy and precision are increased and upgraded, the width or gap between the first alignment layer 206 and the first transfer pad 203, or the width or gap between the second alignment layer 208 and the second transfer pad 204. By this arrangement, the purpose of providing a narrowed frame is further achieved.

Referring to FIG. 5, which is a partial, local illustration showing the first transfer pad 203 of the liquid crystal display made in accordance with the present invention. The array substrate 201 comprises a first glass substrate 501, and the first transfer pad 203. The first transfer pad 203 is disposed onto the array substrate 201. The first transfer pad 203 is made from conductive material. Meanwhile, before the first transfer pad 203 is deployed with alignment liquid, it is surface treated so as to reduce the surface tension thereof. The alignment liquid is deployed over the first glass substrate 501. The area of the alignment liquid reaches to the first transfer pad 203 so as to form a first alignment layer (not labeled).

Referring to FIG. 6, which is partially illustrated an embodiment of the second transfer pad 204 of the liquid crystal display made in accordance with the present invention. The color filter substrate 202 comprises a second glass substrate 502 and a second transfer pad 204. The second transfer pad 204 is disposed onto the color filter substrate 202. The second glass substrate 502 is deposited with three layers of color resist 301 and a layer of transparent conductive layer 302 so as to configure the embossment 303. The embossment 303 servers as the second transfer pad 204 so as to electrically interconnect with the first transfer pad (not labeled). On the other hand, before the alignment liquid is deployed over the second transfer pad 204, it is surface treated so as to reduce its surface tension. The second glass substrate 502 is deployed with alignment liquid to an extent that it reaches to the first transfer pad 203 so as to form the second alignment layer (not labeled).

As compared with the existing technology, the first and second transfer pads are deployed with a lipophillic film, or the first and second transfer pads are surface treated so as to reduce its surface tension. Since the alignment liquid is hydrophilic, there is no concern that the alignment layer will cover the first transfer pad or the second transfer pad. As a result, the alignment layer can be deployed over the first transfer pad or the second transfer pad. As a result, there is no need to pre-save a gap between the first transfer pad or the second transfer pad and the alignment layer. As a result, the strip of non-active area of the liquid crystal display can be properly reduced and the design of narrowed-frame is realized.

Referring to FIGS. 2 to 6, a second embodiment of a liquid crystal display which is similar to the embodiment discussed above is shown.

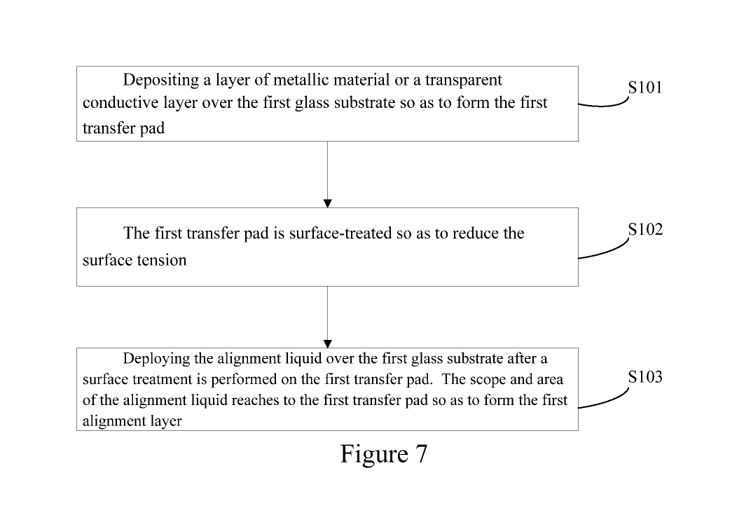

Referring to FIG. 7, along with FIGS. 2 to 6, a liquid crystal display made in accordance with the present invention can be realized by marry of the array substrate 201 and the color filter substrate 202.

A method for making the array substrate 201 is disclosed as below.

Step 101: depositing a layer of metallic material or a transparent conductive layer over the first glass substrate 501 so as to form the first transfer pad 203.

The first transfer pad 203 is electrically interconnected with a common electrode (no labeled), or alternatively, the first transfer pad 203 itself is part of the common electrode. The first transfer pad 203 is distributed on the peripheral of the active area of the liquid crystal display.

Step 102: The first transfer pad 203 is surface treated so as to reduce the surface tension.

The way of performing a surface treatment includes deploying a lipophillic film over the first and second transfer pads. Alternatively, other physical treatment can be applied. The treatment can also include a chemical process such that the hydrophilic material is removed.

In deploying the alignment liquid to form the first alignment layer 206, the alignment liquid can be deployed onto the first transfer pad 203 in way that the alignment liquid on the first transfer pad 203 will automatically run away from the first transfer pad 203 because the hydrophilic properly of the alignment liquid. This can readily prevent the alignment liquid from deploying over the first transfer pad 203. As a result, the first alignment layer 206 can be prevented from in contact with the first transfer pad 203.

Step S103: Deploying the alignment liquid over the first glass substrate after a surface treatment is performed on the first transfer pad. The scope and area of the alignment liquid reaches to the first transfer pad so as to form the first alignment layer 206.

The surface treated area over the first transfer pad 203 determine the distance between the first transfer pad 203 and the first alignment layer 206. Accordingly, by adjusting the range of surface treated area, for example, by broadening its area to the first transfer pad 203, the distance between the first transfer pad 203 and the first alignment layer 206 can be reduced. By this arrangement, the purpose of providing a narrowed frame design can be realized.

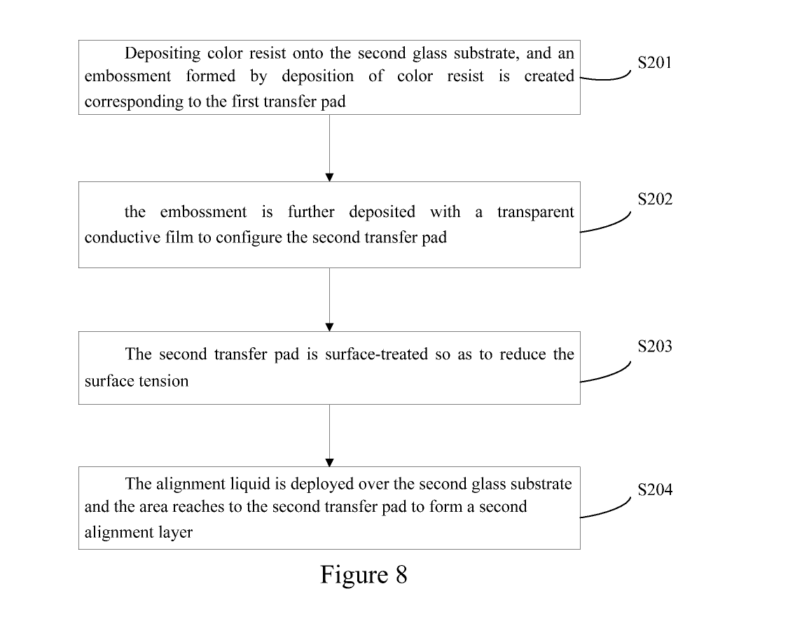

As shown and referring to FIG. 8, along with FIGS. 2 to 6, a manufacturing process re the color filter substrate 202 includes the following steps.

Step S201: Depositing color resist 301 onto the second glass substrate 502. In addition, embossment 303, which is formed by deposition of color resist 301, is created corresponding to the first transfer pad 203. The color resist 301 can be deposited for two layers or more. It should be noted that the color resist 301 in different layers can be identical, or different.

The embossment 303 serves as the second transfer pad 204. The first transfer pad 203 and the second transfer pad 204 are electrically interconnected with each other such that the signal can be readily transmitted from the array substrate 201 to the color filter substrate 202.

The width of the embossment 303 is smaller or equal to the width of the first transfer pad 203. When the adjacent area of the first transfer pad 203 is arranged with other film material, then the width of the embossment 303 can be larger than the width of the first transfer pad 203 such that a better electrical interconnection can be reached between the embossment 303 and the first transfer pad 203.

Step S202, the embossment 303 is further deposited with a transparent conductive film 302 to configure the second transfer pad 204.

The transparent conductive film 302 can be made from indium tin oxide or zinc oxide. The provision of the transparent conductive film 302 ensures a better electrical interconnection between the second transfer pad 204 and the first transfer pad 203.

Step S203: The second transfer pad 204 is surface treated so as to reduce the surface tension.

The surface treatment of the first and second transfer pads is by deployment of a lipophillic film over the surface. The surface can also be treated with physical measurement or by chemical such that a hydrophobic property is achieved.

When deployment of the alignment liquid so as to create the second alignment layer 208, the alignment liquid can be deployed over the second transfer pad 204. Since the alignment liquid is hydrophilic, and the alignment liquid over the second transfer pad 204 will automatically run away thereof. By this arrangement, the alignment liquid can be ensured for not covering the second transfer pad 204. As a result, the second alignment layer 208 is ensured from isolated from the second transfer pad 204.

Step S204: The alignment liquid is deployed over the second glass substrate 502 and the area reaches to the second transfer pad 204. As a result, a second alignment layer 208 is formed.

The scope of the surface treated area determines the distance between the second transfer pad 204 and the second alignment layer 208. Accordingly, by adjusting the area performed with surface treatment, the distance between the second transfer pad 204 and the second alignment layer 208 can be reduced. As a result, the design of narrowed border is realized.

The description above is merely some preferable embodiments of the present invention, while is not intended to limit the implementation of the present invention. Any alternation and/or modifications based on the descriptions and drawings are to be construed as equivalent under the spirit of the present invention, and should be covered by the claims set forth below. On the other hand, even direct and indirect implementation of the present invention to other technology field, should still be covered by the claims as set forth below.

1. An LCD display panel, comprising:
an array substrate;
a color filter substrate in which a color resist and a transparent conductive layer are disposed in sequence, wherein the transparent conductive layer is made from indium tin oxide;
an liquid crystal layer arranged between the color filter substrate and the array substrate, opposing surfaces of both the color filter substrate and the array substrate incorporated with a first transfer pad, arranged onto the array substrate, and a second transfer pad, arranged on the color filter substrate, electrically interconnected therebetween, wherein the second transfer pad is configured by deposition of color resists so as to create a conductive embossments serving as the second transfer pad which in turn in electrical interconnection with the first transfer pad;
an alignment layer disposed in a first space defined by the liquid crystal layer, the array substrate, and the first transfer pad, or alternatively, disposed in a second space defined between the liquid crystal layer, the color filter substrate, and the second transfer pad, or disposed in both the first and second spaces; and
wherein first and second surfaces of both the first and second transfer pads have been pre-treated so as to reduce its surface tension before deployment of the alignment layer.

2. The LCD display panel as recited in claim 1, wherein the surface treatment of the both the first and second transfer pads is to apply a layer of lipophillic film.

3. The LCD display panel as recited in claim 1, wherein the embossments are configured by deposition of two or more than two layers of the color resists.

4. The LCD display panel as recited in claim 1, wherein a width of the embossment is smaller or equal to a width of the first transfer pad.

5. An LCD display panel, comprising:
an array substrate;
a color filter substrate having color resist and transparent conductive layer disposed thereon in sequence;
an liquid crystal layer arranged between the color filter substrate and the array substrate, opposing surfaces of both the color filter substrate and the array substrate incorporated with a first transfer pad, disposed on the array substrate, and a second transfer pad, disposed onto the color filter substrate, to establish an electrical interconnection therebetween;
an alignment layer disposed in a first space defined by the liquid crystal layer, the array substrate, and the first transfer pad, or alternatively, disposed in a second space defined between the liquid crystal layer, the color filter substrate, and the second transfer pad, or disposed both the first and second spaces; and
wherein first and second surfaces of both the first and second transfer pads have been pre-treated so as to reduce its surface tension before deployment of the alignment layer.

6. The LCD display panel as recited in claim 5, wherein the surface treatment of the both the first and second transfer pads is to apply a layer of lipophillic film.

7. The LCD display panel as recited in claim 5, wherein the second transfer pad is formed by deposit of color resist in the form of embossment, and which is served as the second transfer pad so as to establish an electrical interconnection with the first transfer pad.

8. The LCD display panel as recited in claim 7, wherein the embossments are configured by deposition of two or more than two layers of the color resists.

9. The LCD display panel as recited in claim 7, wherein a width of the embossment is smaller or equal to a width of the first transfer pad.

10. The LCD display panel as recited in claim 5, wherein the transparent conductive layer is made from indium tin oxide.

11. The method for making liquid crystal display panel, characterized in that the liquid crystal display panel is configured by an array substrate married with a color filter substrate, the array substrate is fabricated by the steps of:
a) depositing a metallic layer or a transparent conductive layer over a first glass substrate so as to create a first transfer pad;
b) performing a surface treatment over the first transfer pad so as to reduce a surface tension thereof; and
c) deploying an alignment liquid over the first glass substrate which has been surface-treated and covering the first transfer pad so as form a first alignment layer.

12. The method as recited in claim 11, characterized in that:
the color filter substrate is configured with the steps of:
d) depositing color resist on a second glass substrate, and forming a plurality of embossments by means of depositing color resist in a pre-selected area for a second transfer pad;
e) depositing a transparent conductive layer over the embossments so as to form the second transfer pad;
f) performing a surface treatment over the second transfer pad so as to reduce its surface tension thereof; and
g) deploying an alignment liquid over the second glass substrate over the area of the second transfer pad so as to form a second alignment layer.

13. The method as recited in claim 12, wherein the surface treatment of the both the first and/or the second transfer pads is to apply a layer of lipophillic film.

14. The LCD display panel as recited in claim 12, wherein the step of depositing the color resist over the second glass substrate includes the step of depositing two or more than two layers of the color resists over the second glass substrate.

15. The method as recited in claim 12, wherein a width of the embossment is smaller or equal to a width of the first transfer pad.
